(19) United States
(12) Patent Application Publication
(10) Pub. No.: US 2013/0304767 A1
(43) Pub. Date: Nov. 14, 2013

(54) FILLING ATTRIBUTE VALUES OF BUSINESS OBJECTS

(71) Applicant: SANTOSH V, Bangalore (IN)

(72) Inventor: SANTOSH V, Bangalore (IN)

(21) Appl. No.: 13/467,065

(22) Filed: May 9, 2012

(51) Int. Cl. G06F 17/30

(52) U.S. Cl. 707/802; 707/E17.001

(57) ABSTRACT

Various embodiments of systems and methods for tilling attribute values of business objects are described herein. A trigger point to fill a trigger attribute with a value is received. The trigger attribute is associated with a trigger node of a trigger business object. A navigator that defines a navigation path to a source for filling the value for the trigger attribute from the source is identified. The navigator is identified from a router comprising a collection of navigators that define navigation paths to respective sources for filling attribute values of business objects. The router is assigned to the trigger attribute. The value for the trigger attribute is then filled from the source by following the navigation path defined in the identified navigator.

### BACKGROUND

A business object is a software model representing a real-world entity involved in business transactions. For example, a business object may represent a business document such as a sales order, a purchase order, or an invoice. A business object may also represent master data objects such as a product, a business partner, or a piece of equipment. A business object may include business logic and/or data having any suitable structure. The structure of a business object may be determined based on the requirements of a business scenario in which the business object is to be deployed. A business solution for a particular business scenario may include many business objects, where the structure of each business object has been determined based on the requirements of that particular business scenario.

A business object includes a plurality of nodes in a hierarchical configuration. Some of the nodes have attributes. An attribute of a node can get its value from an existing source. The source can be an attribute of a different node in the same business object or in a related business object linked through an association. The source can also be an unrelated business object or any other document. The value for an attribute is copied from such sources. In some cases, changes to the original value are also required to be reflected in the copied value. However, in a typical business scenario, there can be numerous business objects requiring attribute values from a large number of sources. Therefore, managing business objects and their attribute values can be a cumbersome task.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of a business object.

FIG. 2 is a block diagram illustrating cross-business object association.

FIG. 3 is a block diagram illustrating potential sources for filling a trigger attribute.

FIG. 4 is a block diagram of a method for filling attributes of business objects, according to one embodiment.

FIG. 5 is a block diagram illustrating an association navigator defining navigation path between a trigger node and a provider node, according to one embodiment.

FIG. 6 is a block diagram illustrating a navigator defining navigation path between a trigger node and a source, according to one embodiment.

FIG. 7 is a block diagram illustrating router and navigator configuration for filling attributes of business objects, according to one embodiment.

FIG. 8 is a block diagram of an exemplary computer system according to one embodiment.

### DETAILED DESCRIPTION

Embodiments of techniques for filling attribute values of business objects are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

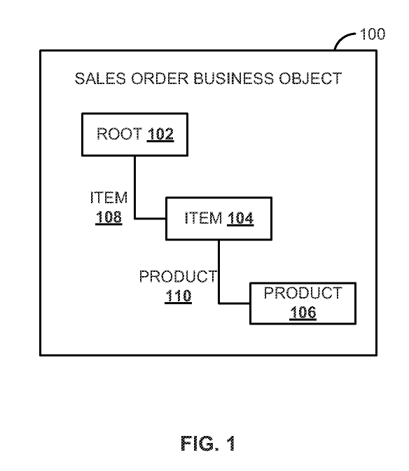

A business object is a software model that represents an identifiable and real-world entity, such as a sales order, involved in a business scenario. Business processes operate on business objects. As an example, a sales order business object 100 is illustrated in FIG. 1. A business object includes nodes in a hierarchical arrangement.

A node can be called as a sub-node if it is placed below another node in the node hierarchy. For example, the sales order business object 100 includes a root node 102, an item node 104, and a product node 106. The item node 104 is a sub-node of the root node 102 and the product node 106 is the sub-node of the item node 104. Each node can have attributes. For example, the root node 102 can have attributes such as ORDER_ID and SHORT_DESCRIPTION. A node and a sub-node are linked together through an association. Association of business object nodes is a way to specify model-level dependency between two business object nodes. An association “ITEM” 108 links the root node 102 and the item node 104. In the context of an association, the root node 102 can be called as the source node and the item node 104 can be called as the target node. Similarly, an association “PRODUCT” 110 links the item node 104 and the product node 106.

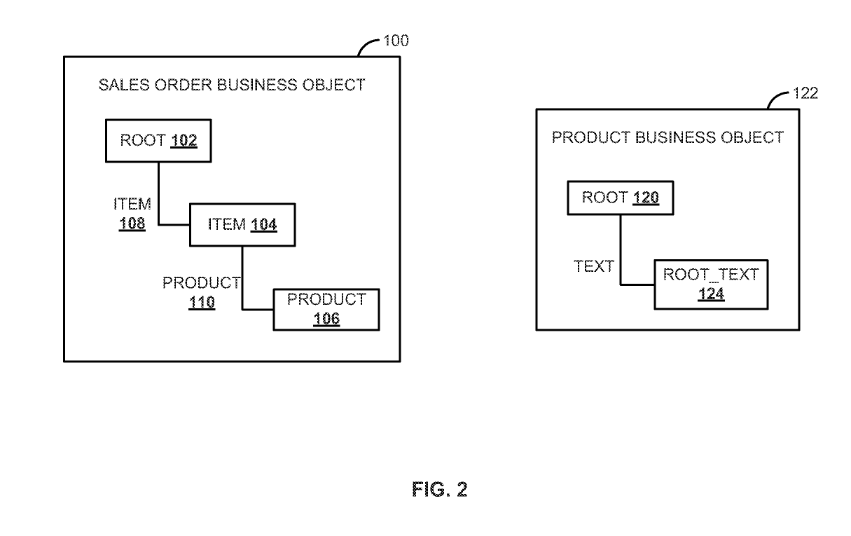

Referring to FIG. 2, a node of a business object can also be linked to a node of a different business object through an association. This type of association is called cross business object (BO) association. For example, the product node 106 of the sales order business object 100 is linked to a root node 120 of a product business object 122. The association between the product node 106 (source node) of the sales order business object 100 and the root node 120 (target node) of the product business object 122 is called cross BO association.

There can be several instances for a particular node. Cardinality of an association specifies the instances of the target node which can exist for an instance of the source node. For example, each instance of the root node 102 of the sales order business object 100 can have instances of the item nodes 104 ranging from zero to any number ‘n,’ indicating a cardinality of 0-n. Each instance of item node 104 can have only one instance of product node 106, indicating a cardinality of 1-l. Also, each instance of the root node 120 of the product business object 122 can have instances of the root_text node 124 ranging from zero to any number ‘n,’ indicating a cardinality of 0-n.

When multiple instances of a target node can exist for the same instance of a source node, a parameterized association can be used to returns a single instance or some instances of the target node for the source node. The instances are filtered using association parameters. For example, the root node 120 and root_text node 124 of the product business object 122 can have an association “TEXT” 126. The root_text node 124 can have an attribute “LANGUAGE” which is used to indicate the language in which the text has been maintained. When traversing from root node 122 to root_text node 124 using association “TEXT,” only one instance will be returned based on the language. The association “TEXT” 126 will have the parameter ‘LANGUAGE” to indicate the language. This type of association for returning a single instance or few instances in some cases is called parameterized association.

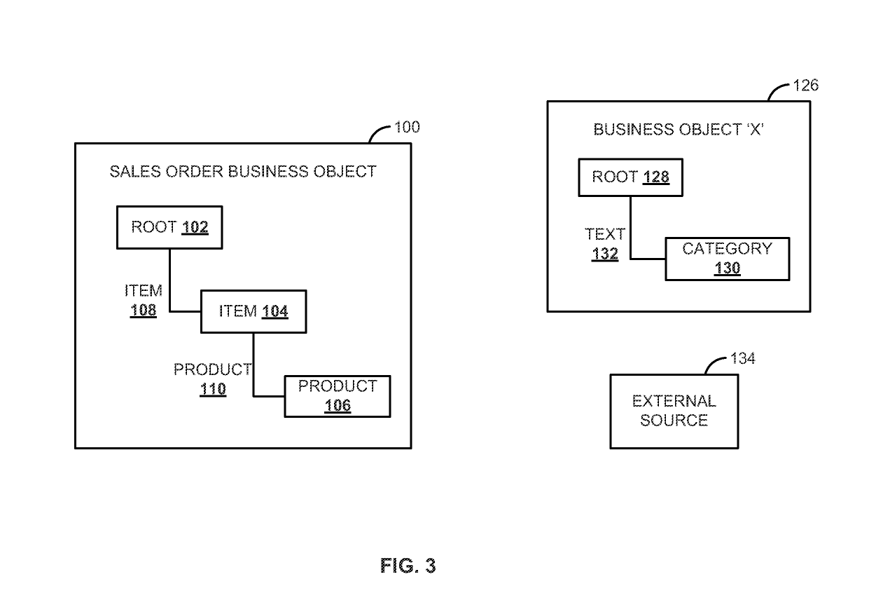

Attributes of some nodes of a business object may need to be copied from a source. The source can be another node in the same business object or another business object linked through cross BO association. For example, an attribute of an instance of the item node 104 of the sales order business object 100 may need to be copied from an instance of the root_text node 124 of the product business object 122. Also, referring to FIG. 3, the source can be a node an unrelated business object 126 that does not have any cross BO association with the sales order business object 100. The unrelated business object 126 also has nodes linked through an association. For example, the root node 128 and the category node 130 of the unrelated business object 126 are linked through an association “TEXY” 132. The source can also be an external source 134 such as a document or a database.

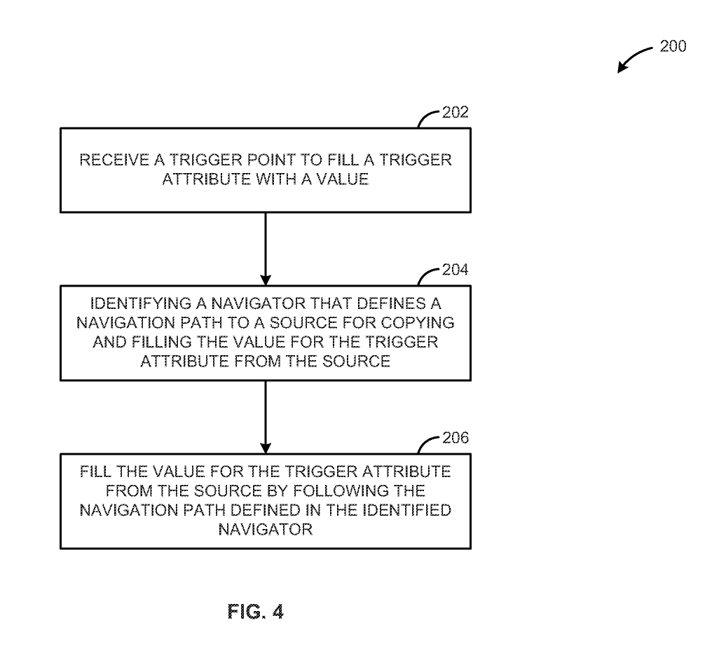

FIG. 4 illustrates a block diagram of an embodiment a method for filling attributes of business objects 200. At 202, a trigger point to fill a trigger attribute is received. The trigger attribute is an attribute of a trigger node that is to be filled from a source. For example, referring to FIG. 2, when an instance of the item node 104 is created, the attributes in the item node such as “PRODUCT_ID” can be filled. But when the instance is saved, the attribute “DESCRIPTION” in the item node 104 may need to be copied from an instance of the product business object 122 corresponding to the PRODUCT_ID. Specifically, the “DESCRIPTION” attribute of the item node 104 may need to be copied from “DESCRIPTION” attribute of the root_text node 124 of an instance of the product business object 122 corresponding to the PRODUCT_ID. The trigger attribute in the above case is “DESCRIPTION” attribute of the item node 104. The item node 104 is called as the trigger node and the sales order business object 100 is called as the trigger business object.

If the source is a business object that is linked to the trigger business object via a cross BO association, then the node attribute from which the value is retrieved and copied into the trigger attribute is called provider attribute. In the above example of FIG. 2, “DESCRIPTION” attribute of the root_text node 124 of the product business object 12 is the provider attribute. The root_text node 124 is the provider node and the product business object 122 is the provider business object. Similarly, referring to FIG. 3, the unrelated business object 126 can be a provider business object and includes a provider node and a provider attribute. The provider node can be the category node 130 and the provider attribute can be “DESCRIPTION” in the category node 130.

In one embodiment, the trigger point is an action. An action is a business logic entity that is assigned to a node of a business object. An action can modify a node in its own business object or in any other business object. Actions can be triggered from an external source. For example, an action “Deliver” can be modeled on the root node of sales order business object. This “Deliver” action is triggered as soon as the sales order is delivered. In one embodiment, the action can be triggered from a button on a user interface.

In one embodiment, the trigger point is a determination. A determination is an element of a business object node that describes internal change in business logic on the business object. A determination contains business object specific logic to perform side effects and is executed if a business object internal event occurs. Determinations can react on the creation, deletion, or loading from an instance by deriving new values for fields. For example, a determination on the root node of sales order business object can be modeled to fill an attribute “CREATED_BY” with the user name of a user who logged in.

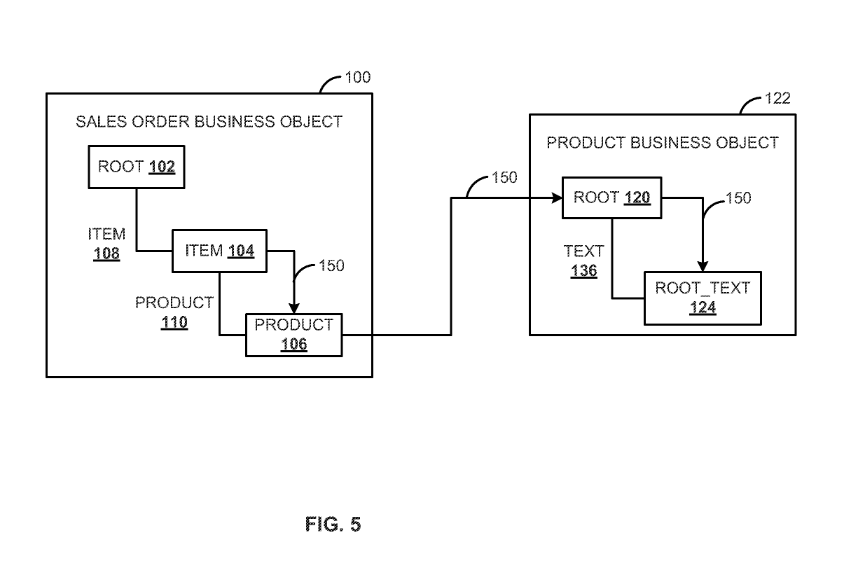

Referring back to FIG. 4, at 204, in response to the trigger point, a navigator that defines a navigation path from the trigger node to a source is identified, in one embodiment, a developer of business objects defines a navigator. A unique identifier is assigned to each navigator. A navigator defines a navigation path from the trigger node to a source. If the source is another business object linked to the trigger business object via cross BO association, then the navigator defines a path from the trigger node to the provider node of the provider business object. This type of navigator is called an association navigator. Referring to the FIG. 5, an association navigator defines a navigation path from the trigger node 104 (item node) to the provider node 124 (root_text node). The navigation path 150 is illustrated using arrows. The navigation starts from the trigger node 104 and sequentially traverses through any intermediate nodes of the trigger business object 100 and the provider business object 122 to reach the provider node 124. In one embodiment, the provider node can be a sub-node of the provider business object and the navigation path starts from the trigger node, traverses through any sub-nodes of the trigger node, traverses through root node or any parent nodes of the provider node, and ends at the provider node. For example, the navigation path from the item node 104 to the root_text node 124 starts from the item node 104, traverses through the product node 106 of the trigger business object 100 and the root node 120 of the provider business object 122, and ends at the root_text node 124 of the provider business object 122. In another embodiment, the provider node can be a root node of the provider business object.

In one embodiment, sequence numbers cart be used for defining a navigation path for an association navigator. The sequence numbers can be assigned to the associations involved in the path from the trigger node to the provider node. For example, in the navigation path from the item node 104 to the root_text node 124, a sequence number 10 can be assigned to the “PRODUCT” association 110 and a sequence number 20 can be assigned to the “TEXT” association 136. The “TEXT” association 136 links the root node 120 and root_text node 124 of the provider business object 122. The navigation path is evaluated in the ascending order of the sequence numbers. In one embodiment, the sequence numbers are not contiguous. This enables accommodating any intermediate associations for nodes that may be created for existing business objects. For example, a new intermediate association can be assigned a sequence number of 15.

To create a new navigator, a developer can assign a unique identifier for the new navigator, assign the type for the navigator, and assign sequence numbers for the associations linking nodes in the navigation path. Table 1 below shows a definition for the association navigator. The type for the navigator is an association, meaning that the new navigator is an association navigator and the unique identifier is “ProdText.”

TABLE 1
Navigator ID - ProdText
Navigator type - Association

| Sequence number | Association |
|---|---|
| 10 | PRODUCT |
| 20 | TEXT |

Navigation through the associations provides one target instance for each association. If the cardinality is more than ‘1,’ then the first instance of the target node instances is considered. In another embodiment, the instances can be filtered using a parameterized association when the cardinality is more than ‘1,’ In case of parameterized associations, the value of the association can be provided. The parameter value can be either a constant such as ‘EN’ which refers to the language ‘English’ or a derivable such as ‘SY-LANGU’ which refers to the language of a user who is currently logged-in. In one embodiment, when both a constant and a derivable are provided, then the derivable is evaluated first and, if no value is found, then the constant is considered as a default value.

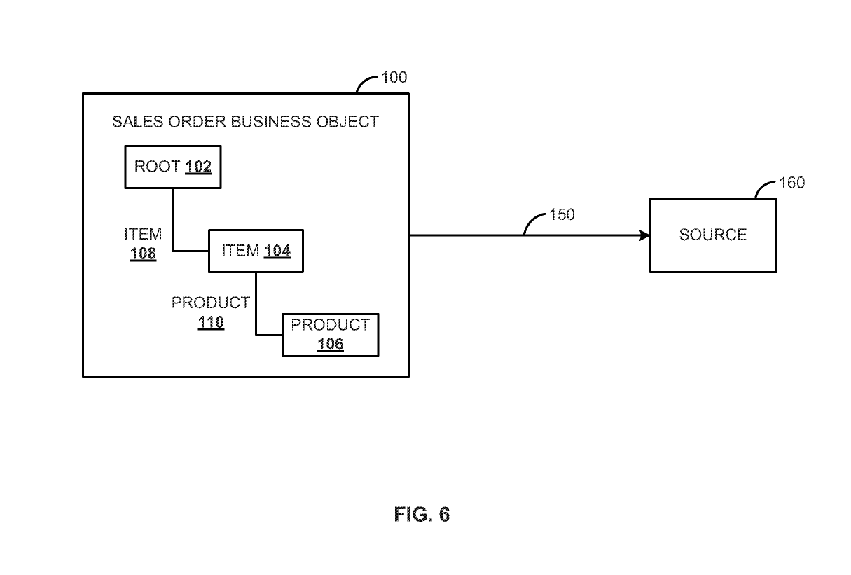

Referring to FIG. 6, the trigger attribute can be filled from other source 160 such as an unrelated business object that is not linked to the trigger node by a cross BO association. If a provider node is in the unrelated business object, then an external business object navigator is created. The external business object navigator defines the navigation path 150 to the source, i.e. an external business object. To create an external business object navigator, a unique identifier is assigned to the navigator, the type for the navigator is defined, and a class is developed to implement an interface. An application developer has to implement this class and provide necessary details. In one embodiment, trigger information is passed to a method of the class and provider information can be determined from this trigger information. Provider information can include provider attribute, provider node, and provider business object and trigger information can include trigger attribute, trigger node, and trigger business object. A table for association navigation can be created from the trigger information and the provider information. The association navigation details in this table can be sent to the invoking method of the class. Table 2 shows a definition for the external business object navigator,

TABLE 2

Navigator ID - ExtBOBP
Navigator type - External business object
Class - CL_RETRIEVE_EXTERNAL_BP

In one embodiment, the source 160 can be an external source such as a document or a database. For example, an application can require information that may not be available as a business object. Such information can be stored in a database or can be in a document. An external navigator is created in such cases. The external navigator defines the navigation path 150 to the source 160. To create an external source navigator, a unique identifier is assigned to the navigator and the type for the navigator is defined. Also, a class is developed to implement an interface. An application developer implements this class and provides necessary details, in one embodiment, values for parameters which are required to retrieve information from an external source are determined. For example, to retrieve text from an external source, an identifier, name, and an object are required. An application programming interface (API) is then called to retrieve the information from the external source. For example, the API can be a function module such as “READ_TEXT.” Once the information is retrieved, data may need to be formatted in some cases. For example, once text data is retrieved, newline characters might need to be interpreted. Finally, the value is passed back to assign to the trigger attribute. Table 3 below shows a definition for the external source navigator including an example code in Advanced Business Application Programming (ABAP) language defining a navigation path.

TABLE 3
Navigator ID - ExtS1
Navigator type - External source
Class - CL_RETRIEVE_EXTERNAL_SOURCE1

* Data declarations

DATA : lt_content TYPE TABLE OF tline,

ls_content TYPE tline,
ls_parameters TYPE /bofu/s_ext_param_value,
id_value TYPE thead-tdid,
name_value TYPE thead-tdname,
object_value TYPE thead-tdobject,
lv_output type string.

* Fill the id, name and the object's value

READ TABLE it_parameters WITH KEY param_name = ‘ID’ INTO ls_parameters.
IF sy-subrc = 0.

id_value = ls_parameters-param_value.

ENDIF.
READ TABLE it_parameters WITH KEY param_name = ‘NAME’ INTO ls_paramet

ers.

IF sy-subrc = 0.

name_value = ls_parameters-param_value.

ENDIF.
READ TABLE it_parameters WITH KEY param_name = ‘OBJECT’ INTO ls_param

eters.

IF sy-subrc = 0.

object_value = ls_parameters-param_value.

ENDIF.

* Call the function module Read_text to get the text from the SO10 transaction.

IF id_value IS NOT INITIAL AND name_value IS NOT INITIAL AND object_value

IS NOT INITIAL.

CALL FUNCTION ‘READ_TEXT’

| EXPORTING | |
|---|---|
| id | = id_value |
| language | = sy-langu |
| name | = name_value |
| object | = object_value |
| TABLES | |
| lines | = lt_content |

* Fill all the text into the text field of text data structue.
loop at lt_content into ls_content.

if ls_content-tdformat EQ space or ls_content-tdformat EQ ‘=’.

concatenate lv_output ls_content-tdline into lv_output.
else.

concatenate lv_output CL_ABAP_CHAR_UTILITIES=>NEWLINE into
lv_output
concatenate lv_output ls_content-tdline into lv_output.

endif.

endloop.
es_text_data-text = lv_output.

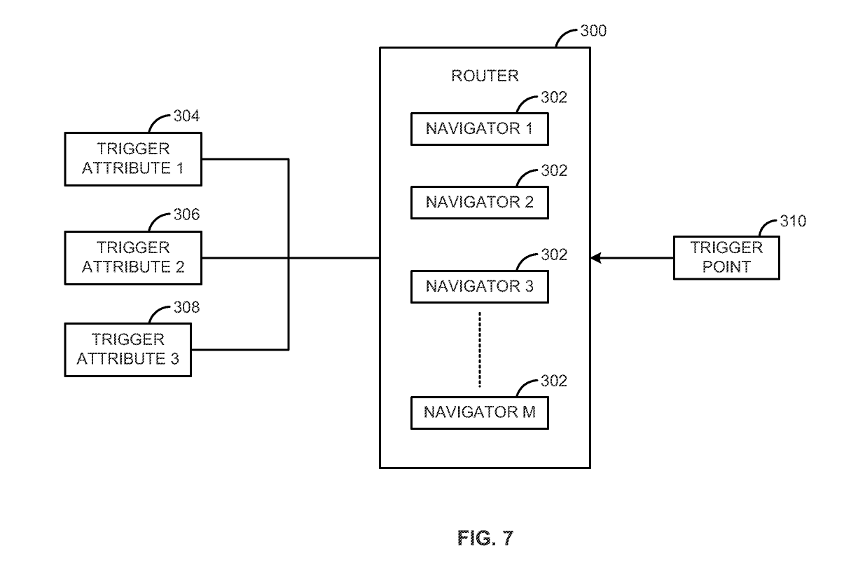

Referring to FIG. 7, the navigator is identified from a router 300. A router 300 is a collection of navigators 302. When these navigators 302 are created, they are assigned to the router 300. These navigators 302 can include association navigators, external business object navigators, and external navigators. For example, “navigator 1” can be an association navigator, “navigator 2” can be an external business object navigator, and “navigator M” can be an external navigator. One or more trigger attributes 304, 306, and 308 are assigned to the router 300. These trigger attributes 304, 306, and 308 can belong to the same business object or different business objects. In a typical business scenario, there can be several routers and each router includes a collection of navigators and one or more trigger attributes are assigned to each router.

The navigators 302 in the router are processed in response to the trigger point 310. The trigger point 310 is a time point when a trigger attribute has to be automatically filled. As mentioned previously, the trigger point can be an action or a determination. The source for the trigger attribute is defined by a navigator that is in a respective router. For example, consider that the trigger point requires that the “trigger attribute 3” 308 is to be filled and “Navigator 2” defines the navigation path to a source to fill the “trigger attribute 3” 308. Since the “trigger attribute 3” 308 is assigned to the router 300, the trigger point 310 starts processing of the router 300. The navigators 302 in the router are processed to identify a source for the “trigger attribute 3” 308.

In one embodiment, a priority can be assigned to the navigators 302 and the navigators 302 are processed in the order of the priority. The priority can be assigned based on business requirement. Some scenarios require an order for the sources that should be followed when filling an attribute. Priorities can be assigned based on this order. For example, a scenario may require that the Product node should be checked first to see if it includes a Description, if the Product node does not have a Description, then a Product Category node to which the Product belongs to) should be checked to see if there is any Description. An association navigator can define a navigation path to the Product node and an external business object navigator can define a navigation path to the Product Category node. Therefore, the association navigator is assigned a higher priority compared to the external business object navigator.

When a source which contains a value for the “trigger attribute 3” 308 is found, further navigators are not processed. For example, “Navigator 1” is processed first, followed by “Navigator 2” and so on until “Navigator M”. If a navigator (Navigator 2) containing a provider attribute for the “trigger attribute 3” 308 is identified, then the further navigators (navigators 3 to M) are not processed.

Referring back to FIG. 4, after the navigator is identified for the trigger attribute, the value for the trigger attribute is filled from the source by following the navigation path defined in the identified navigator, at 206. Therefore, in response to the trigger point, an appropriate navigator is identified and the value for the trigger attribute is automatically filled from a respective source. For example, referring to FIG. 7, the value for the “trigger attribute 3” 308 is filled from the source defined in the “Navigator 2.” If the “Navigator 2” is an association navigator, the provider attribute value is copied and filled in the value for the “trigger attribute 3” 308. Similarly, if the “Navigator 2” is an external business object navigator, then the provider attribute value from the external business object is copied and filled in the value for the “trigger attribute 3” 308. If the “Navigator 2” is an external navigator, a corresponding value in a document or a database is copied and filled in the value for the “trigger attribute 3” 308.

In one embodiment, when assigning a navigator to a router, a referencing option can be selected or deselected. If the reference option is selected, then after the value for the trigger attribute is copied and filled, the value of the trigger attribute is automatically updated to reflect any change in the provider attribute value, if the reference option is not selected, then the value of the trigger attribute is not updated if there is any change to the provider attribute value. Also, in one embodiment, if the value of the trigger attribute is changed manually, then any change in the provider attribute value is not reflected in the trigger attribute.

The above-described method can be embodied in a business object processing framework. A business object processing framework is used to implement business objects. Such frameworks control application business logic and data retrieval of buffer and persistency layer. A business object processing framework provides various user interfaces to create, change, and manage business objects. User interface features that enable creation of navigators, creation of routers, assigning navigators to a router, assigning trigger attributes to a router, defining a navigation path, and referencing options can be provided in such frameworks.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

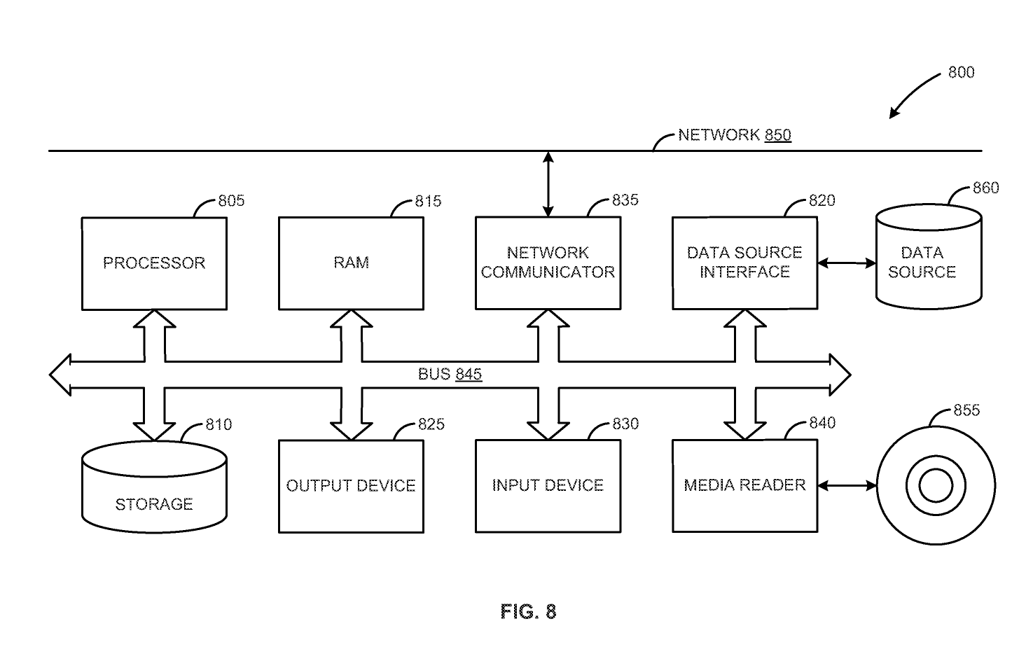

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a non-transitory computer readable storage medium to tangibly store instructions, which when executed by a computer, cause the computer to:
receive a trigger point to fill a trigger attribute with a value, wherein the trigger attribute is associated with a trigger node of a trigger business object;
identify a navigator that defines a navigation path from the trigger node to a source for filling the value for the trigger attribute from the source, wherein the navigator is identified from a router comprising a collection of navigators that define navigation paths to respective sources for filling attribute values of business objects and the router is assigned to the trigger attribute,
wherein the navigators comprise an association navigator that defines a navigation path from the trigger node to a provider node of a provider business object; and
fill the value for the trigger attribute from the source by following the navigation path defined in the identified navigator.

2. The article of manufacture of claim 1, wherein the provider node includes a provider attribute and the provider business object is related to the trigger business object via a cross-business object association.

3. The article of manufacture of claim 2, wherein the instructions to fill the value for the trigger attribute comprises instructions to:
copy the value for the trigger attribute from a value of the provider attribute.

4. The article of manufacture of claim 3, further comprising instructions which when executed cause the computer to:
after the value is filled for the trigger attribute, automatically update the value of the trigger attribute for a change in the value of the provider attribute.

5. The article of manufacture of claim 2, wherein a first instance of the provider node is considered if cardinality is more than one.

6. The article of manufacture of claim 2, wherein an instance of the provider node is considered based on a parameterized association.

7. The article of manufacture of claim 1, wherein the navigators comprise:
an external business object navigator that defines a navigation path from the trigger node to a provider node of an external business object that is not associated with the trigger business object; and
an external source navigator that defines a navigation path from the trigger node to an external source.

8. The article of manufacture of claim 1, wherein the trigger point includes at least one of an action assigned to a business object node or a determination.

9. A computer-implemented method for filling attributes of business objects, the method comprising:
receiving a trigger point to fill a trigger attribute with a value, wherein the trigger attribute is associated with a trigger node of a trigger business object;
identifying a navigator that defines a navigation path to a source for filling the value for the trigger attribute from the source, wherein the navigator is identified from a router comprising a collection of navigators that define navigation paths to respective sources for filling attribute values of business objects and the router is assigned to the trigger attribute; and
filling the value for the trigger attribute from the source by following the navigation path defined in the identified navigator.

10. The method of claim 9, wherein the navigators comprise an association navigator that defines a navigation path from the trigger node to a provider node of a provider business object, the provider node includes a provider attribute and the provider business object is related to the trigger business object via a cross-business object association.

11. The method of claim 10, filling the value for the trigger attribute comprising:
copying the value for the trigger attribute from a value of the provider attribute

12. The method of claim 10, further comprising:
after the value is filled for the trigger attribute, automatically updating the value of the trigger attribute for a change in the value of the provider attribute.

13. The method of claim 10, wherein a first instance of the provider node is considered if cardinality is more than one.

14. The method of claim 10, wherein an instance of the provider node is considered based on a parameterized association.

15. The method of claim 9, wherein the navigators comprise:
an external business object navigator that defines a navigation path from the trigger node to a provider node of an external business object that is not associated with the trigger business object; and
an external source navigator that defines a navigation path from the trigger node to an external source

16. The method of claim 9, wherein the trigger point includes at least one of an action assigned to a business object node or a determination.

17. A computer system for filling attributes of business objects, comprising:
a computer memory to store program code; and
a processor to execute the program code to:
receive a trigger point to fill a trigger attribute with a value, wherein the trigger attribute is associated with a trigger node of a trigger business object;
identify a navigator that defines a navigation path to a source for filling the value for the trigger attribute from the source, wherein the navigator is identified from a router comprising a collection of navigators that define navigation paths to respective sources for filling attribute values of business objects and the router is assigned to the trigger attribute; and
fill the value for the trigger attribute from the source by following the navigation path defined in the identified navigator.

18. The system of claim 17, wherein the navigators comprise an association navigator that defines a navigation path from the trigger node to a provider node of a provider business object, the provider node includes a provider attribute and the provider business object is related to the trigger business object via a cross-business object association

19. The system of claim 18, wherein the program code to fill the value for the trigger attribute, comprises program code to:
copy the value for the trigger attribute from a value of the provider attribute

20. The system of claim 19, wherein the processor further executes the program code to:
after the value is filled for the trigger attribute, automatically update the value of the trigger attribute for a change in the value of the provider attribute

21. The system of claim 18, wherein a first instance of the provider node is considered if cardinality is more than one.

22. The system of claim 18, wherein an instance of the provider node is considered based on a parameterized association.

23. The system of claim 17, wherein the navigators comprise:
an external business object navigator that defines a navigation path from the trigger node to a provider node of an external business object that is not associated with the trigger business object; and
an external source navigator that defines a navigation path from the trigger node to an external source.

24. The system of claim 15, wherein the trigger point includes at least one of an action assigned to a business object node or a determination.
